(19) United States
(12) Patent Application Publication
(10) Pub. No.: US 2026/0277502 A1
(43) Pub. Date: Sep. 17, 2026

(54) EVENT-DRIVEN TECHNICAL SUPPORT FOR A PRINTER

(71) Applicants: Ping Zhang, Boulder, CO (US); Karan Bantia Ram, Boulder, CO (US); Benjamin Kohav, Boulder, CO (US); Patrick Gonzalez, Boulder, CO (US); Ryszard Ligas, Boulder, CO (US); Tadao Yamasaki, Boulder, CO (US); Ruchita Lad, Boulder, CO (US)

(72) Inventors: Ping Zhang, Boulder, CO (US); Karan Bantia Ram, Boulder, CO (US); Benjamin Kohav, Boulder, CO (US); Patrick Gonzalez, Boulder, CO (US); Ryszard Ligas, Boulder, CO (US); Tadao Yamasaki, Boulder, CO (US); Ruchita Lad, Boulder, CO (US)

(73) Assignee: Ricoh Company, Ltd., Tokyo (JP)

(21) Appl. No.: 19/077,029

(22) Filed: Mar. 11, 2025

(51) Int. Cl. G06F 3/12

(52) U.S. Cl. CPC G06F 3/121; G06F 3/1234; G06F 3/1285

(57) ABSTRACT

System, method, and software for event-driven technical support for a printer. In an embodiment, a print monitor device is configured to receive moderated operational data streaming from a printer, monitor the moderated operational data streaming from the printer to detect an error at the printer, and determine whether the error comprises a critical error based on error detection criteria. When the error comprises a critical error based on the error detection criteria, the print monitor device is configured to upload a critical error indication to a cloud-based technical support service over at least one network connection, automatically collect log data from the printer, and automatically upload the log data to the cloud-based technical support service over the at least one network connection.

### TECHNICAL FIELD

The following disclosure relates to the field of printing, and more particularly, to printing services.

### BACKGROUND

Image formation is a procedure whereby one or more digital images are recreated by applying a marking material (e.g., ink, toner, etc.) to a printable medium, such as paper. Image forming apparatuses are used as printers, facsimile machines, copiers, plotters, multi-functional devices or multi-function peripherals (MFPs), etc. Errors may occur in image formation (also referred to generally as printing or printing process), such as at a printer. Some errors may require that a technician visit the site of the printer to diagnose the problem, and technical support such as this may be slow, inefficient, and expensive.

### SUMMARY

Embodiments described herein provide enhanced technical support services for image formation apparatuses, such as printers. As an overview, a print monitor device is deployed on-premises or on-ground with a printer or multiple printers. The print monitor device monitors operational data of a printer to detect errors encountered at the printer. When a critical error is encountered, the print monitor device informs a cloud-based technical support service of the error and uploads log data generated by the printer to the cloud-based technical support service. The cloud-based technical support service in turn may analyze the log data remotely to assist a printer operator in resolving the critical error. One technical benefit is the technical support service is able to provide assistance more expeditiously and more cost-effective, which improves productivity and customer satisfaction.

In an embodiment (also referred to as aspects), an apparatus comprises a print monitor device comprising at least one processor and memory configured to cause the print monitor device at least to receive moderated operational data streaming from a printer, monitor the moderated operational data streaming from the printer to detect an error at the printer, and determine whether the error comprises a critical error based on error detection criteria. When the error comprises a critical error based on the error detection criteria, the at least one processor and memory is further configured to cause the print monitor device at least to upload a critical error indication to a cloud-based technical support service over at least one network connection, automatically collect log data from the printer, and automatically upload the log data to the cloud-based technical support service over the at least one network connection.

Other embodiments may include computer readable media, other systems, or other methods as described below.

The above summary provides a basic understanding of some aspects of the specification. This summary is not an extensive overview of the specification. It is intended to neither identify key or critical elements of the specification nor delineate any scope particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments of the present disclosure are now described, by way of example only, and with reference to the accompanying drawings. The same reference number represents the same element or the same type of element on all drawings.

FIG. 1 is a diagram of a print system in an illustrative embodiment.

FIG. 2 is a schematic diagram of an image forming apparatus in an illustrative embodiment.

FIG. 3 is a block diagram of a technical support system in an illustrative embodiment.

FIG. 4 is a block diagram of a print monitor device in an illustrative embodiment.

FIGS. 5A-5C are flow charts illustrating a method of providing technical support in illustrative embodiments.

FIGS. 6A-6C are communication diagrams regarding a technical support system in an illustrative embodiment.

FIG. 7 is a block diagram of a technical support system in an illustrative embodiment.

FIG. 8 is a flow chart illustrating a method of providing technical support in an illustrative embodiment.

FIG. 9 is a block diagram of a technical support system in an illustrative embodiment.

FIG. 10 illustrates communication between a print monitor device and a technical support service in an illustrative embodiment.

FIG. 11 illustrates communication between a print monitor device and a technical support service in an illustrative embodiment.

FIG. 12 is a block diagram of a print monitor device in another illustrative embodiment.

FIG. 13 is a block diagram of a print monitor device in an illustrative embodiment.

FIG. 14 is a flow chart illustrating additional steps of the method of FIG. 5A in an illustrative embodiment.

FIG. 15 is a block diagram of a print monitor device in an illustrative embodiment.

FIG. 16 is a flow chart illustrating additional steps of the method of FIG. 5C in an illustrative embodiment.

FIG. 17 is a block diagram of a print monitor device in an illustrative embodiment.

FIGS. 18A-18B are flow charts illustrating additional steps of the method of FIG. 5A in illustrative embodiments.

FIGS. 19A-19B are communication diagrams regarding communications with a printer operator in illustrative embodiments.

FIG. 20 is a block diagram of an assistance server in an illustrative embodiment.

FIG. 21 is a flow chart illustrating a method of providing technical support in an illustrative embodiment.

FIGS. 22A-22B are schematic diagrams illustrating training and deployment of AI models in an illustrative embodiment.

FIG. 23 illustrates a processing system operable to execute a computer readable medium embodying programmed instructions to perform desired functions in an illustrative embodiment.

### DETAILED DESCRIPTION

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

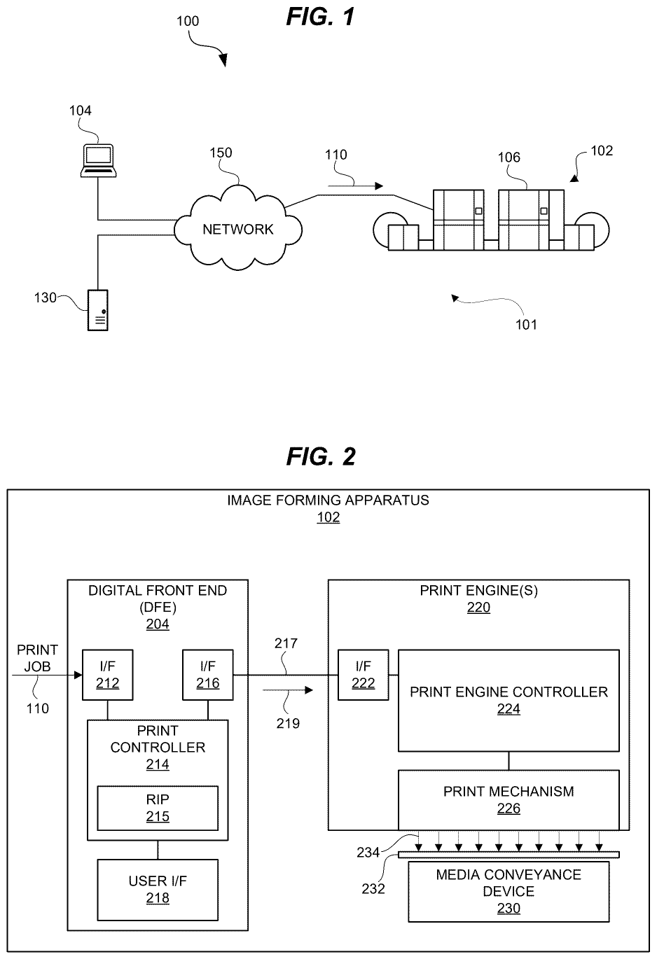

FIG. 1 is a diagram of a print system 100 in an illustrative embodiment. A print system 100 in general comprises one or more print devices 101 (also referred to as print-related devices, print equipment, print apparatuses, etc.) that produce printed material based on one or more print jobs 110. In an embodiment, a print system 100 may comprise one or more image forming apparatuses 102. An image forming apparatus 102 (also referred to as a printer 106 herein) may comprise an apparatus that performs image formation (printing) on a recording or printable medium by applying colorants or marking/recording material on the basis of print data. Although shown as a continuous-form printer, a printer 106 or printing device described herein may comprise a cut-sheet printer, a wide-format printer, a Multi-Function Peripheral (MFP), a 3-D printer, etc. A printer 106 is configured to receive a submission in the form of a print job 110, and process the print job 110 to produce printed material. A print job 110 is a unit of work to be run on a printer 106 or on another type of image forming apparatus 102. A print job 110 may comprise one or more print files (e.g., a Portable Document Format (PDF) file), may comprise job information such as a job ticket (e.g., a Job Definition Format (JDF) job ticket) containing instructions to process and print a job, etc.

Print system 100 may comprise one or more host devices 104. A host device 104 (also referred to as a host terminal, a client device, etc.) is an information processing apparatus or end user device that submits print files for printing. Although shown as a personal computer (PC), a host device 104 may comprise a laptop, a mobile device, or another type of device that runs or executes a software program or application configured to submit a job for printing. Print system 100 may comprise one or more print servers 130. A print server 130 (also referred to as a management server) is a server apparatus that communicatively couples a host device 104 to one or more printers 106. The print server 130 may be configured to manage print requests from a host device 104, generate print jobs 110 based on data received in the print requests, submit print jobs 110 to one or more printers 106, etc. For example, a print request from a host device 104 may comprise one or more print files or documents, instructions for printing of the print files, etc.

One or more print devices 101 of a print system 100 may be configured to perform data communication with one another via a communication network 150. The communication network 150 may comprise, for example, a network including a local area network (LAN), a wide area network (WAN), such as the Internet, etc., and may comprise a wired network, a wireless network, or a network including both of a wired network and a wireless network. A print system 100 may be configured for professional, commercial, production, or industrial printing. Commercial printing may be performed by Print Service Providers (PSP) or other providers that offer printing services to users/customers in exchange for monetary compensation. For example, a PSP may offer printing services for advertising or marketing materials, product manuals, books, invoices/bills, blueprints, mailings, etc. A PSP may own or operate a variety of printing equipment, referred to generally as a print shop. For example, a print shop may include one or more printers 106 and/or other print equipment (e.g., post-print devices, finishing devices, etc.).

FIG. 1 illustrates one example of a print system 100 that may be implemented by a printer operator, although other types of print systems are considered herein. For example, a print system 100 may comprise a cloud printing service implemented on a cloud computing platform. The cloud printing service may be configured to manage print requests from a host device 104, generate print jobs 110 based on data received in print requests, submit print jobs 110 to one or more printers 106, etc.

FIG. 2 is a schematic diagram of an image forming apparatus 102 in an illustrative embodiment. Image forming apparatus 102 is a type of device that executes an image forming process (e.g., printing process) on a recording or printable medium. In an embodiment, image forming apparatus 102 includes a Digital Front End (DFE) 204, and one or more print engines 220. DFE 204 is an information processing apparatus configured to accept a print job 110, and convert the print job 110 into a suitable format for a print engine(s) 220. More particularly, DFE 204 generates print data 219 by a raster image processor (RIP) engine on the basis of the print job 110, and transmits the print data 219 to the print engine(s) 220. In an embodiment, DFE 204 may be on-ground or on-premises with the print engine(s) 220. In general, “on-ground” or “on-premises” means that the infrastructure exists on-site in contrast to being hosted off-site. DFE 204 may be implemented on a separate (on-premises) platform from the print engine(s) 220, or may be integrated on a platform of the print engine(s) 220. In an embodiment, DFE 204 may communicate with the print engine(s) 220 over a communication network.

In an embodiment, DFE 204 includes an Input/Output (I/O) interface 212, a print controller 214, and a print engine interface 216, and may also include a user interface 218 (also referred to as an operator console). I/O interface 212 comprises an apparatus, device, circuitry, means, and/or other component configured to receive a print job 110 from a source, such as a host device 104, a print server 130, a cloud printing service, etc. I/O interface 212 may be considered a network interface in some embodiments. The print job 110 comprises one or more print files (also referred to as job files or vector files) formatted with a Page Description Language (PDL), such as PostScript, Printer Command Language (PCL), Intelligent Printer Data Stream (IPDS), etc. The print job 110 may also comprise a job ticket containing instructions, requirements, and/or other control information for processing and/or printing a print job, such as a JDF job ticket. Print controller 214 comprises an apparatus, device, circuitry, means, and/or other component configured to transform the print job 110 into print data 219 comprising one or more digital images (also referred to as raster images or halftone images) that may be used by print engine 220 to mark a printable medium 232 with ink, toner, or another recording or marking material. In an embodiment, print controller 214 includes a Raster Image Processor (RIP) 215 that translates or rasterizes the print job 110 to generate digital images or raster images that a printer can understand and print. A digital or raster image comprises a two-dimensional array of pixels or dots, also referred to as a bitmap (e.g., halftone bitmap). Whereas the print file(s) of the print job 110 in PDL format is a high-level description of the content (e.g., text, graphics, pictures, etc.), a digital image defines a pixel value or color value for each pixel in a display space. Print engine interface 216 comprises an apparatus, device, circuitry, means, and/or other component configured to communicate with a print engine(s) 220, such as to transmit digital images to the print engine(s) 220. Print engine interface 216 may be communicatively coupled to a print engine(s) 220 via one or more communication links 217 (e.g., a fiber link, a bus, a communication cable, etc.), and is configured to transfer the digital images to the print engine(s) 220. User interface 218 is a component configured to interact with a human operator. A human operator may access user interface 218 to view status indicators or updates, view or manipulate settings, schedule print jobs, etc.

Print engine 220 includes a DFE interface 222, a print engine controller 224, and a print mechanism 226 (or multiple print mechanisms). DFE interface 222 comprises an apparatus, device, circuitry, means, and/or other component configured to interact with DFE 204, such as to receive print data 219 from DFE 204. Print engine controller 224 comprises an apparatus, device, circuitry, means, and/or other component configured to process the print data 219 (e.g., the digital or raster images) received from DFE 204, and provide control signals to print mechanism 226. Print mechanism 226 is an image formation device (or devices) that marks the printable medium 232 with a recording material 234. Print mechanism 226 may be configured for variable droplet or dot size to reproduce multiple intensity levels. Printable medium 232 comprises any type of material suitable for printing upon which recording material 234 is applied, such as paper (web or cut-sheet), plastic, card stock, transparent sheets, cloth, etc. In an embodiment, print mechanism 226 may include one or more printheads that are configured to jet or eject droplets of a print liquid, such as ink (e.g., water-based, solvent-based, oil-based, or UV-curable), through a plurality of orifices or nozzles. The orifices or nozzles may be grouped according to ink types (e.g., colors such as Cyan (C), Magenta (M), Yellow (Y), Key black (K) or formulas such as for pre-coat, image and protector coat, etc.), which may be referred to as color planes. In another embodiment, print mechanism 226 may include a drum that selectively collects electrically-charged powdered ink (toner), and transfers the toner to printable medium 232. Media conveyance device 230 may be configured to move printable medium 232 relative to print mechanism 226. In other embodiments, portions of print mechanism 226 may be configured to move relative to printable medium 232. Image forming apparatus 102 may include various other components not specifically illustrated in FIG. 2.

In a print operation of a print job 110, there may be an error or fault (also referred to as a print error, printing error, printing process error, etc.) in printing of the print job 110. For example, an error may occur at a DFE 204 of a printer 106 in processing or rasterizing the print job 110, at a print engine 220 in marking a printable medium, a safety interlock switch may trigger, internal components (e.g., fans, motors, rollers, turnbars, etc.) may fail, etc. In some scenarios, a printer operator may be able to diagnose the cause of an error on-site, and resolve the error. In other scenarios, a printer operator may be unable to determine the cause of the error, and may utilize or contact a technical support provider to troubleshoot or debug the error.

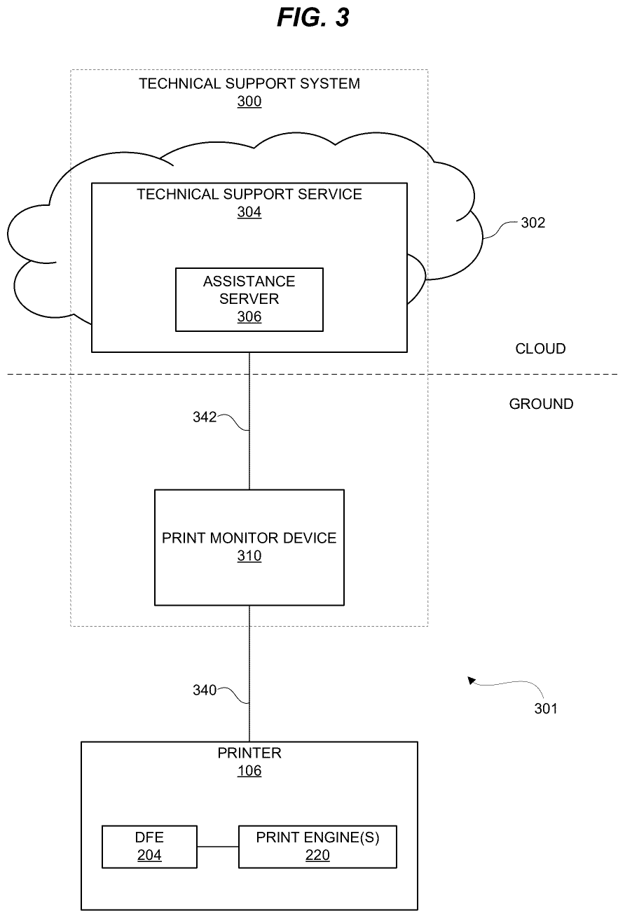

FIG. 3 is a block diagram of a technical support system 300 in an illustrative embodiment. Technical support system 300 is configured to provide a technical support service 304 regarding printers 106 and/or other print devices 101. The technical support service 304 may be a fee-based service, may be a service offered by a manufacturer of a printer 106 or other type of print device 101, etc. Technical support system 300 comprises one or more print monitor devices 310 (also referred to as print monitor agents), which is an information processing apparatus, device, circuitry, means, and/or other component configured to monitor or supervise operation of one or more print devices 101, such as a printer 106. A print monitor device 310 is deployed on-ground or on-premises with print device(s) being monitored. As in FIG. 3, a print monitor device 310 is on-ground with a printer 106 being monitored. As will be described in further detail below, print monitor device 310 is communicatively coupled with one or more printers 106 (e.g., via a wired or wireless connection) to exchange data, information, commands, instructions, etc.

Technical support system 300 further includes an assistance server 306 deployed in the cloud. More particularly, the assistance server 306 is implemented on a cloud-computing platform 302. Cloud-computing allows users access to a variety of services over an internet connection. Some examples of cloud-computing platform 302 may comprise Amazon Web Services (AWS), Google Cloud, Microsoft Azure, etc. Assistance server 306 may be configured to analyze errors or faults detected in print devices, offer assistance to a printer operator in resolving errors, etc.

The architecture of technical support system 300 may be considered a hybrid architecture that combines the infrastructure of a public cloud (illustrated by cloud-computing platform 302), and on-ground or on-premise infrastructure 301 comprising one or more print monitor devices 310. As described above, “on-ground” or “on-premises” means that the infrastructure exists on-site in contrast to being hosted off-site, such as in a public cloud. A print monitor device 310 is communicatively coupled to the cloud-based technical support service 304, and is also communicatively coupled to one or more printers 106 and/or other print devices 101. For example, print monitor device 310 may be directly connected to one or more printers 106 via a direct connection 340 (e.g., wired or wireless connections), and is connected to the cloud-based technical support service 304 over one or more network (e.g., internet) connections 342. The internet as referred to herein is a system of interconnected computer networks that uses the Internet Protocol suite (e.g., Transmission Control Protocol/Internet Protocol (TCP/IP)) to communicate between networks and devices, although other protocols may be developed in the future.

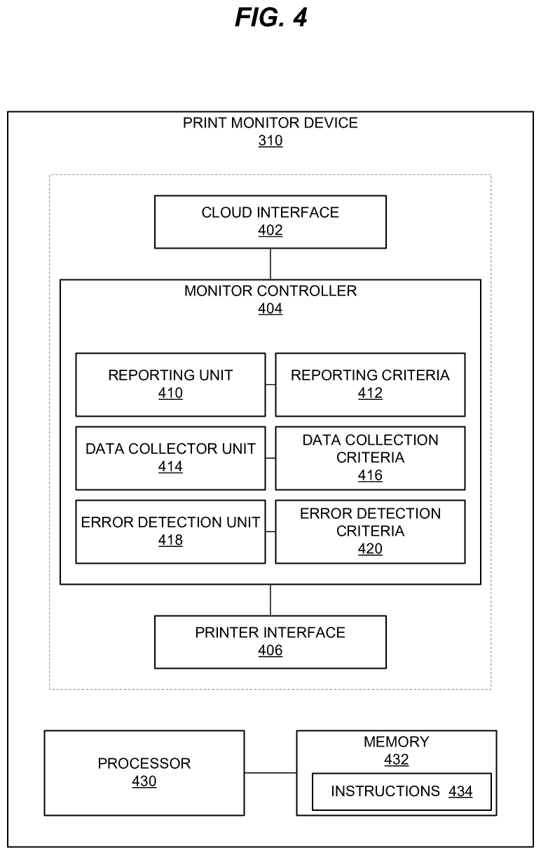

FIG. 4 is a block diagram of a print monitor device 310 in an illustrative embodiment. In an embodiment, print monitor device 310 includes the following subsystems: a cloud interface 402, a monitor controller 404, and a printer interface 406. Cloud interface 402 (also referred to as a cloud connector) is an information processing apparatus comprising circuitry, logic, hardware, an application, means, etc., configured to communicate with a cloud-based server or service, such as technical support service 304 and/or assistance server 306. Cloud interface 402 is configured to provide or establish one or more connections or communication channels with the technical support service 304 and/or assistance server 306, to manage communication with the technical support service 304 and/or assistance server 306, etc. Cloud interface 402 may use a variety of protocols for communication, such as an Application Programming Interface (API), data and/or network management protocols, transfer protocols, messaging protocols, etc.

Printer interface 406 (also referred to as a printer connector) is an information processing apparatus comprising circuitry, logic, hardware, an application, means, etc., configured to communicate with one or more printers 106 and/or other printing devices/equipment (e.g., post-print or finishing devices). Printer interface 406 may use a variety of protocols for communication. For example, printer interface 406 may exchange communications with printers 106 based on a native printer interface protocol of the printers 106, an API (e.g., Fiery API), TCP/IP, Line Printer Remote (LPR) protocol, Internet Printing Protocol (IPP), Postscript over a Transmission Control Protocol (TCP) port, Hypertext Transfer Protocol (HTTP)/HTTPS, Simple Network Management Protocol (SNMP), Job Messaging Format (JMF) protocol, etc.

Monitor controller 404 is communicatively coupled between cloud interface 402 and printer interface 406. Monitor controller 404 is an information processing apparatus comprising circuitry, logic, hardware, an application, means, etc., configured to monitor operations of a printer 106 or other print device/equipment for errors or faults. In an embodiment, monitor controller 404 may comprise a reporting unit 410 configured to report data or information to the technical support service 304, assistance server 306, and/or another entity based on reporting criteria 412. Monitor controller 404 may comprise a data collector unit 414 configured to collect, obtain, or retrieve operational data from a print device. Data collector unit 414 may collect, obtain, or retrieve operational data from a print device based on data collection criteria 416. Monitor controller 404 may comprise an error detection unit 418 configured to detect errors or faults encountered in a print device based on operational data associated with the print device. Error detection unit 418 may detect errors or faults based on error detection criteria 420.

One or more of the subsystems of print monitor device 310 may be implemented on a hardware platform comprised of analog and/or digital circuitry. One or more of the subsystems of print monitor device 310 may be implemented on a processor 430 that executes instructions 434 stored in memory 432. A processor 430 comprises an integrated hardware circuit configured to execute instructions 434 to provide the functions of print monitor device 310. Processor 430 may comprise a set of one or more processors or may comprise a multi-processor core, depending on the particular implementation. Memory 432 is a non-transitory computer readable medium for data, instructions, applications, etc., and is accessible by processor 430. Memory 432 is a hardware storage device capable of storing information on a temporary basis and/or a permanent basis. Memory 432 may comprise a random-access memory, or any other volatile or non-volatile storage device.

Print monitor device 310 may comprise various other components not specifically illustrated in FIG. 4.

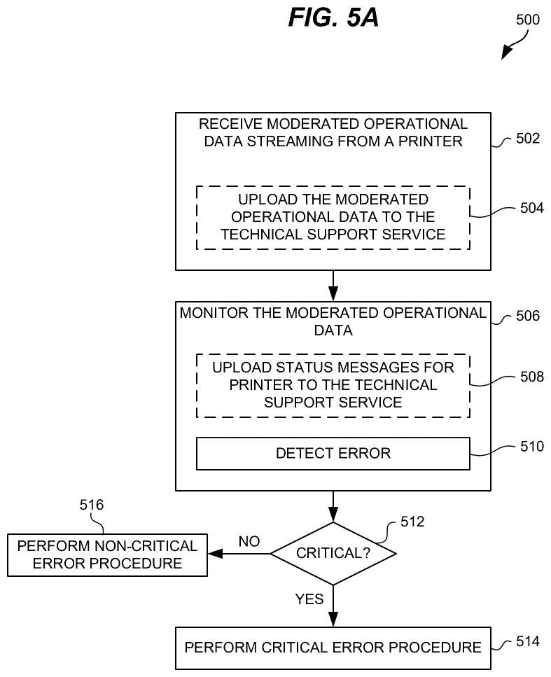

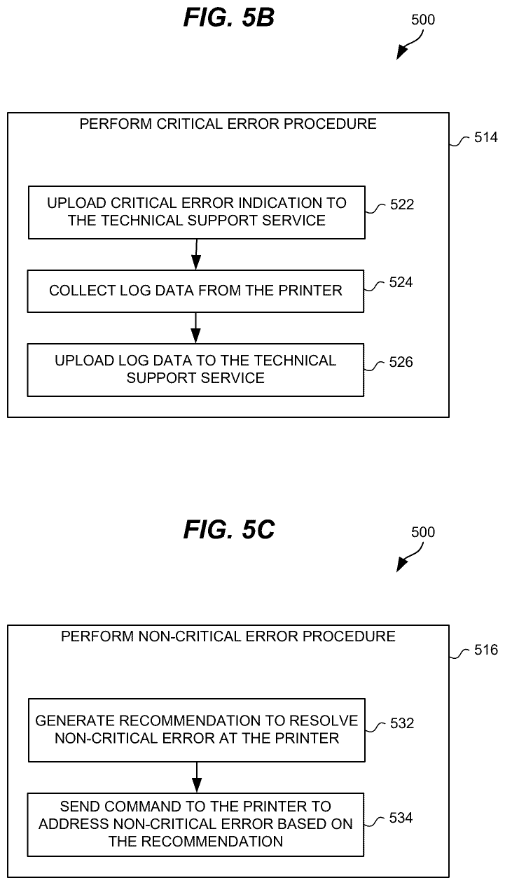

FIGS. 5A-5C are flow charts illustrating a method 500 of providing technical support in illustrative embodiments. The steps of method 500 will be described with reference to the print monitor device 310 in FIG. 4, but those skilled in the art will appreciate that the methods (also referred to as processes) described herein may be performed in other systems or devices. Also, the steps of the flow charts described herein are not all inclusive and may include other steps not shown, and the steps may be performed in an alternative order.

As illustrated in FIG. 3, print monitor device 310 has a communication link or connection 340 with a printer 106, or sets up a connection 340 with the printer 106. With the connection 340 established, data collector unit 414 of print monitor device 310 collects data from the printer 106, such as when the printer 106 is idle, while the printer 106 is actively processing a print job 110, etc. In FIG. 5A, print monitor device 310 receives moderated operational data streaming from a printer 106 (step 502). In general, operational data comprises real-time information regarding execution of tasks, transactions, and/or functions within a printer or another type of print device. The operational data may be considered streaming data as the operational data is received in a continuous or substantially continuous manner. The amount of operational data that can be generated, such as during a printing process, may be voluminous, and it may not be feasible to stream this voluminous amount of data between a printer 106 and print monitor device 310. Thus, “moderated” operational data is streamed in one embodiment. Moderated operational data is a reduced or limited volume or amount compared to the total amount of operational data generated by a printer 106.

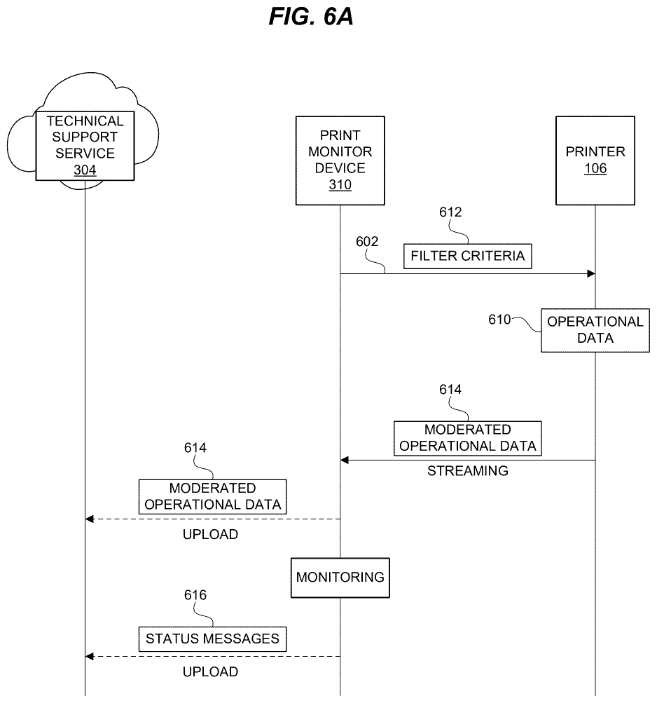

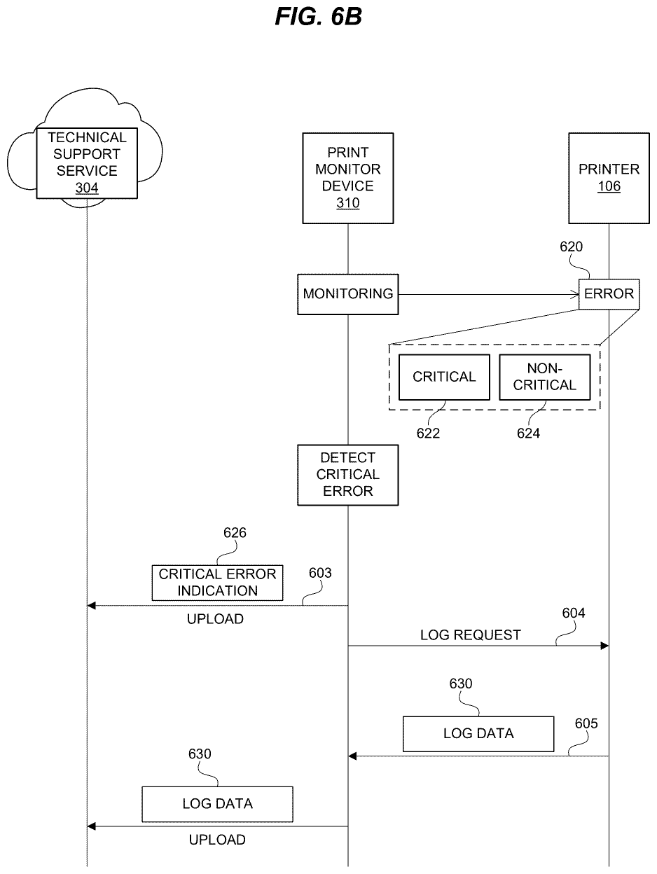

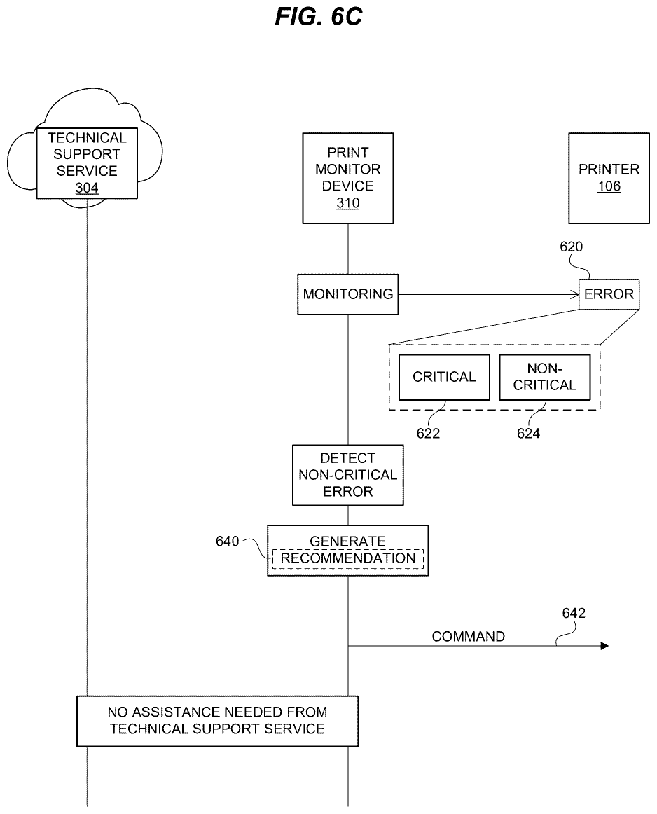

In an embodiment, print monitor device 310 may provide criteria or rules to the printer 106 to specify the content of the moderated operational data. FIG. 6A is a communication diagram regarding technical support system 300 in an illustrative embodiment. One assumption is that the printer 106 generates operational data 610, such as during a printing process of a print job 110. Print monitor device 310 may send a control message 602 to the printer 106 containing filter criteria 612. The filter criteria 612 defines the type of operational data 610 desired by print monitor device 310 for monitoring. For example, the filter criteria 612 may specify certain operational data 610 be reported for productive tracking or the like. Based on the filter criteria 612, printer 106 identifies a subset of the operational data 610 as the moderated operational data 614, and streams the moderated operational data 614 to the print monitor device 310. One technical benefit is the volume of data sent from the printer 106 to the print monitor device 310 is reduced, and customized for the monitoring performed by the print monitor device 310.

In an embodiment, print monitor device 310 (through reporting unit 410) reports or provides certain data or information to the technical support service 304 based on the reporting criteria 412. In an embodiment, the reporting criteria 412 may specify that the moderated operational data 614 received from the printer 106, or a portion thereof, be reported to the technical support service 304. Thus, print monitor device 310 may upload the moderated operational data 614 (or a portion thereof) to the technical support service 304 (see optional step 504 in FIG. 5A). As illustrated in FIG. 6A, print monitor device 310 may upload the moderated operational data 614 received from the printer 106 to the technical support service 304. Print monitor device 310 may upload the moderated operational data 614 contemporaneously with receipt of the moderated operational data 614 streaming from the printer 106. In other words, as print monitor device 310 streams moderated operational data 614 in real-time (or near real-time), print monitor device 310 may upload the moderated operational data 614 in real-time. One technical benefit is print monitor device 310 feeds real-time operational data to the technical support service 304 so that the technical support service 304 is able to monitor operation of the printer 106, if desired.

In FIG. 5A, print monitor device 310 monitors the moderated operational data 614 (step 506). As the moderated operational data 614 is streaming, print monitor device 310 parses the data in real-time to detect events in the data. In an embodiment, print monitor device 310 may detect status indicators in the moderated operational data 614, which indicate a status of the printer 106 and/or print job 110. The reporting criteria 412 may specify that the status indicators for a printer 106 be reported to the technical support service 304. Thus, print monitor device 310 may upload one or more status messages to the technical support service 304 (optional step 508). As illustrated in FIG. 6A, print monitor device 310 may upload status messages 616 to the technical support service 304 when detecting status indicators in the moderated operational data 614. One technical benefit is the print monitor device 310 feeds real-time data to the technical support service 304 so that the technical support service 304 is informed of the status of the printer 106.

In FIG. 5A, when monitoring the moderated operational data 614, print monitor device 310 (through error detection unit 418) may detect an error encountered in the printer 106 (step 510). FIG. 6B is a communication diagram regarding technical support system 300 in an illustrative embodiment. When an error 620 is detected, print monitor device 310 determines whether the error 620 is a critical error 622 (see step 512 in FIG. 5A). Print monitor device 310 may determine or evaluate whether an error 620 is critical based on the error detection criteria 420. A critical error 622 (also referred to as a fatal error) may cause a stop or halt to a printing process, while a non-critical error 624 may not cause a stop or halt to a printing process. When the error 620 comprises a critical error 622, print monitor device 310 initiates or performs a critical error procedure (see step 514 in FIG. 5A). When the error 620 comprises a non-critical error 624, print monitor device 310 initiates or performs a non-critical error procedure (see step 516 in FIG. 5A).

FIG. 5B illustrates a critical error procedure. For the critical error procedure, print monitor device 310 (e.g., through reporting unit 410) reports certain data or information to the technical support service 304, such as based on the reporting criteria 412. For example, print monitor device 310 uploads or provides a critical error indication to the technical support service 304 (step 522). As illustrated in FIG. 6B, print monitor device 310 sends, reports, or provides a reporting message 603 to the technical support service 304 that contains a critical error indication 626 over at least one network connection 342. One technical benefit is the technical support service 304 is informed of the critical error 622 encountered at the printer 106.

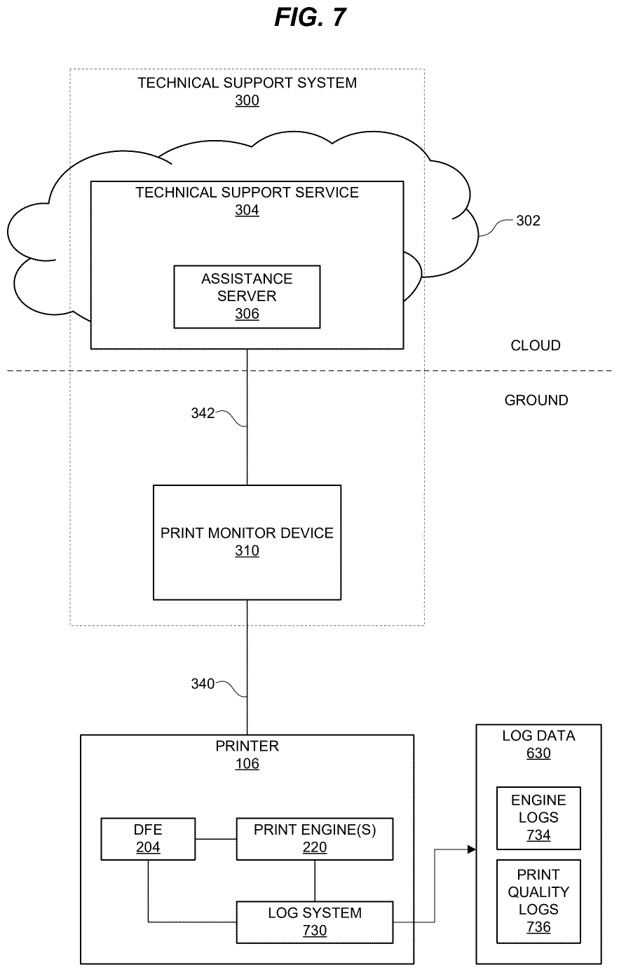

Print monitor device 310 collects or acquires (e.g., automatically) log data 630 from the printer 106 (see step 524 in FIG. 5B), as illustrated in FIG. 6B. FIG. 7 is a block diagram of a technical support system 300 in an illustrative embodiment. A printer 106 may include or implement a log system 730 configured to generate log data 630 (also referred to as a log file(s)), such as during a printing process. Log data 630 is information (e.g., text files) of printer activity, operations, events, etc., created and stored in the printer 106. Log data 630 is used to monitor activity and/or troubleshoot problems occurring in the printer 106. For example, the log data 630 may comprise one or more engine logs 734 (or engine log files) for one or more print engines 220 of the printer 106. In another example, the log data 630 may comprise one or more print quality logs 736 for one or more color planes of the printer 106. For example, printer 106 may include an inspection system or the like configured to verify that a print engine(s) 220 is operating correctly. An inspection system may include an imaging device, such as a camera, scanner, densitometer, spectrophotometer, or other suitable component for acquiring images or a representation of printed content from a print engine(s) 220. The imaging device obtains images of printed content (e.g., a printed test chart), and the images are analyzed in the inspection system to identify any defects or artifacts. The inspection system may generate print quality logs 736 for one or more color planes of the printer 106. The log data 630 generated by log system 730 is voluminous. For example, the log data 630 may comprise job information, state or status information of a job or the printer, trace data, error codes, warning codes, sensor data (e.g., fan speed measurements, temperature measurements, voltage/current measurements, roller speed measurements, safety interlock signals, etc.), and/or other data. Thus, one technical benefit is print monitor device 310 waits until a critical error 622 is encountered before collecting the log data 630 from the printer 106, which improves efficiency.

In FIG. 6B, print monitor device 310 may collect the log data 630 by sending a log request 604 to the printer 106 requesting the log data 630. In response, the printer 106 may send a log response 605 to print monitor device 310 with the log data 630. In another example, the log request 604 from the print monitor device 310 may request that the printer 106 automatically push the log data 630 in response to an event, such as certain error codes. Print monitor device 310 may collect certain types of log data 630 based on the type of critical error 622 detected. For example, if an error code determined to be a critical error 622 indicates a failure at a print engine 220, then print monitor device 310 may request engine logs 734. If an error code determined to be a critical error 622 indicates a failure at another location other than a print engine 220 (e.g., a feed roller, a take-up roller, a turnbar, etc.), then print monitor device 310 may request other log data 630. Print monitor device 310 may include instructions in the log request 604 indicating what log data 630 is being requested.

Print monitor device 310 then uploads or provides (e.g., automatically) the log data 630 to the technical support service 304 (step 526). As illustrated in FIG. 6B, print monitor device 310 uploads the log data 630 to the technical support service 304 over at least one network connection 342. One technical benefit is the technical support service 304 is provided with the log data 630 of the printer 106 to troubleshoot or debug the critical error 622.

FIG. 5C illustrates a non-critical error procedure. For the non-critical error procedure, print monitor device 310 may perform one or more operations or functions on-ground without having to contact or involve the technical support service 304. For example, print monitor device 310 may generate a recommendation to resolve the non-critical error 624 at the printer 106 (step 532). FIG. 6C is a communication diagram regarding technical support system 300 in an illustrative embodiment. When the detected error 620 is determined to be a non-critical error 624, print monitor device 310 generates a recommendation 640 to resolve the non-critical error 624. Print monitor device 310 then sends or provides a command 642 to the printer 106 to address the non-critical error 624 based on the recommendation 640 (see step 534 in FIG. 5C). One technical benefit is the print monitor device 310 is able to fix or remedy one or more problems or issues at the printer 106 that caused the non-critical error 624. Thus, print monitor device 310 may not need assistance from the technical support service 304.

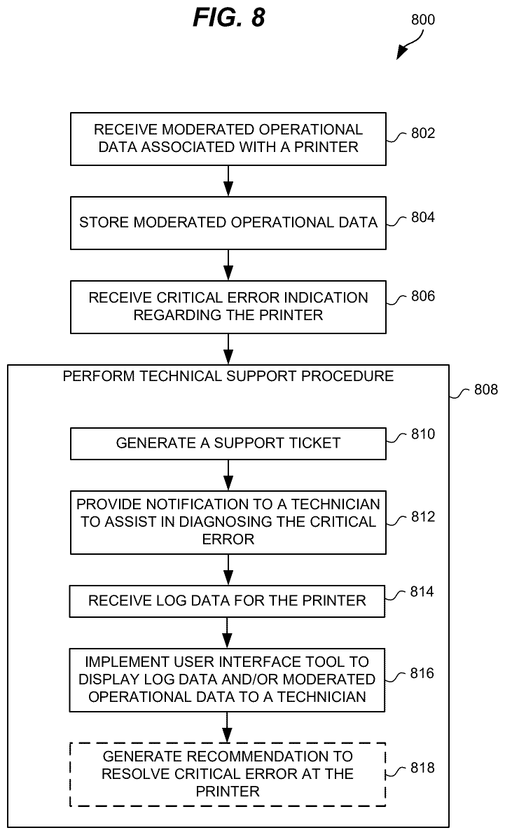

FIG. 8 is a flow chart illustrating a method 800 of providing technical support in an illustrative embodiment. The steps of method 800 will be described with reference to the assistance server 306 implemented in the cloud. Assistance server 306 receives the moderated operational data 614 uploaded by the print monitor device 310 for a printer 106 (step 802), and stores the moderated operational data 614 (step 804). Assistance server 306 may store the moderated operational data 614 along with an identifier (ID) associated with the printer 106, such as a serial number of the printer 106, a customer/user ID, etc. Assistance server 306 receives a critical error indication 626 from the print monitor device 310 indicating a critical error 622 encountered at the printer 106 (step 806). In response to the critical error indication 626, assistance server 306 initiates or performs a technical support procedure (step 808). For the technical support procedure, assistance server 306 may generate a support ticket for a customer/user (step 810), which is the owner or operator of the printer 106.

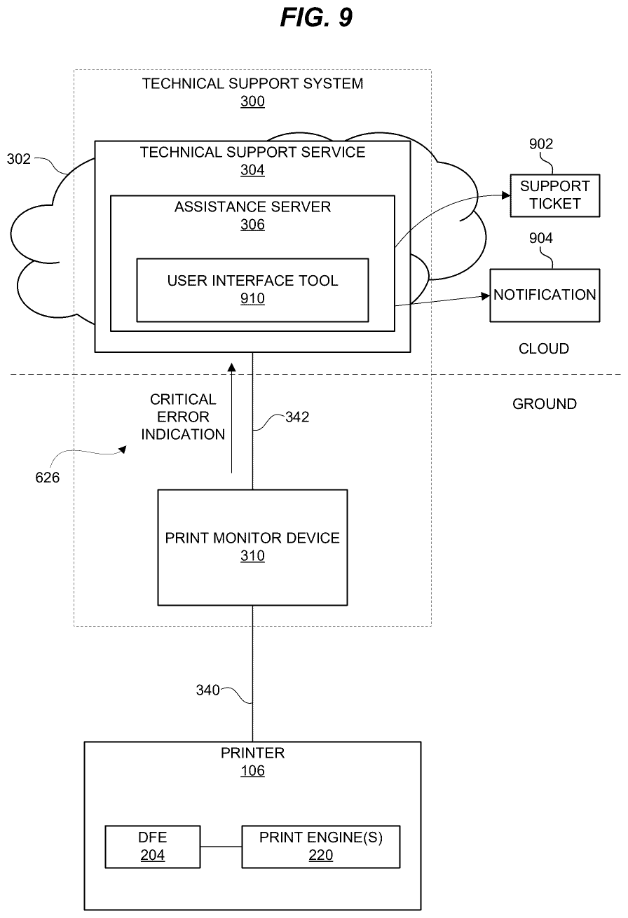

FIG. 9 is a block diagram of a technical support system 300 in an illustrative embodiment. Assistance server 306 opens or generates a support ticket 902 for the customer when a critical error indication 626 is received. Assistance server 306 may send or provide (e.g., automatically) a notification 904 to a technician or support team member to assist in diagnosing the critical error 622 (step 812). For example, assistance server 306 may send the notification 904 as a text message, an email, a pop-up window, etc. Assistance server 306 receives the log data 630 for the printer 106 uploaded by print monitor device 310 (step 814). In an embodiment, assistance server 306 may implement a user interface tool 910 that provides a Graphical User Interface (GUI) (step 816). The user interface tool 910 may display a notification 904 to a technician or support team member to assist in diagnosing the critical error 622. The user interface tool 910 may display the log data 630 and/or the moderated operational data 614 uploaded by the print monitor device 310. The technician may therefore analyze the log data 630 and/or the moderated operational data 614 to determine a resolution for the critical error 622. In an embodiment, assistance server 306 may generate a recommendation to resolve the critical error 622 (optional step 818) based on the log data 630 and/or the moderated operational data 614, and provide the recommendation to print monitor device 310, to the customer or printer operator, etc. One technical benefit is the technical support service 304 provides on-demand assistance when a critical error 622 is encountered at a printer 106.

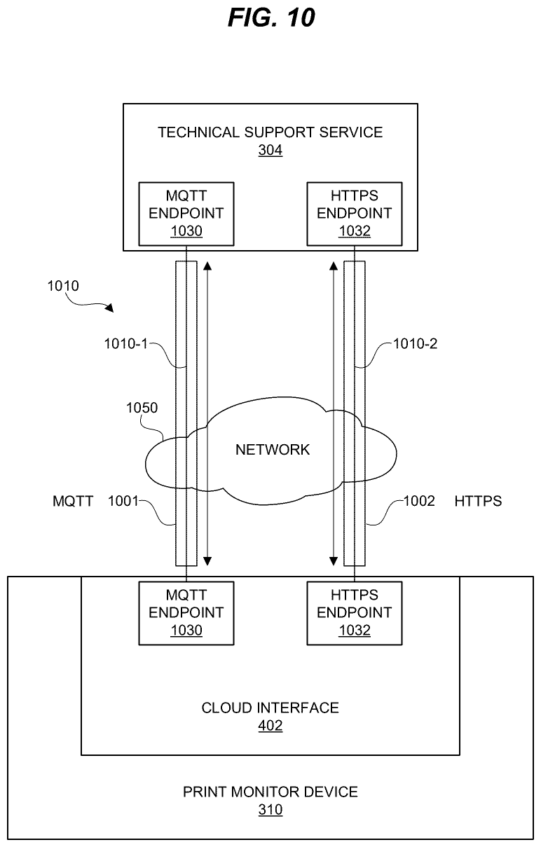

In an embodiment, print monitor device 310 communicates with the technical support service 304 over multiple network connections. FIG. 10 illustrates communication between print monitor device 310 and technical support service 304 in an illustrative embodiment. Print monitor device 310 and technical support service 304 may be communicatively coupled over a network 1050 (e.g., the internet) through a plurality of network connections 1010 (also referred to as communication channels). A first one of the network connections 1010-1 may use a secure messaging protocol for communication, and may also be referred to as a messaging interface. A second one of the network connections 1010-2 may use a secure transfer protocol for communication, and may also be referred to as a data transfer interface. A secure messaging protocol is an application layer protocol (e.g., Layer-7 of the network protocol stack, such as the Open Systems Interconnection (OSI) model) comprising rules, formats, and/or functions for exchanging messages (i.e., print-related messages) between the cloud and a ground system. The secure messaging protocol has a constraint of a maximum message size, which is a message or payload less than a threshold, such as 128 kilobytes (KB), 256 KB, 512 KB, etc. One example of the secure messaging protocol is Message Queuing Telemetry Transport (MQTT) protocol 1001, which is a standards-based messaging protocol used for machine-to-machine communication. Thus, cloud interface 402 and technical support service 304 may each implement an MQTT endpoint 1030, which is an application, module, etc., configured to communicate via MQTT protocol 1001. The MQTT endpoint 1030 of cloud interface 402 may be referred to as an MQTT client, and the MQTT endpoint 1030 of technical support service 304 may be referred to as an MQTT broker.

A secure transfer protocol is an application layer protocol configured to transfer information (i.e., print-related data) between networked or network-connected devices. One example of the secure transfer protocol is Hypertext Transfer Protocol Secure (HTTPS) 1002, which is an extension of the Hypertext Transfer Protocol (HTTP). HTTPS is an application layer protocol in the IP suite that uses Transport Layer Security (TLS) encryption for secure communication over a network, such as the internet. Thus, cloud interface 402 and technical support service 304 may each implement an HTTPS endpoint 1032, which is an application, module, etc., configured to communicate via HTTPS 1002. The HTTPS endpoint 1032 of cloud interface 402 may be referred to as an HTTPS client, and the HTTPS endpoint 1032 of technical support service 304 may be referred to as an HTTPS server (or vice-versa depending on the direction of communication).

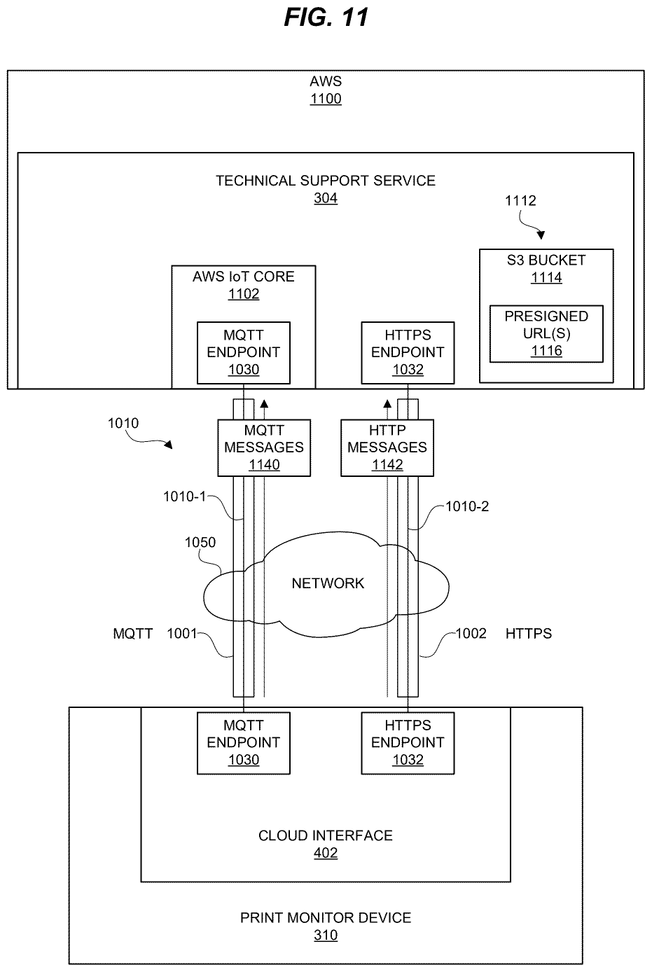

FIG. 11 illustrates communication between print monitor device 310 and technical support service 304 in an illustrative embodiment. In an embodiment, the technical support service 304 may be implemented in an AWS environment 1100. AWS is a platform that offers flexible and scalable cloud computing solutions. Thus, AWS environment 1100 comprises an environment that uses an AWS platform or a type of AWS platform (also referred to as an AWS-type environment), such as one that includes future developments of AWS or other Amazon cloud services. The AWS environment 1100 includes the AWS Internet of Things (IoT) Core 1102, which is a managed cloud service that lets connected devices easily and securely interact with cloud applications and other devices. The AWS IoT Core 1102 provides a fully managed palette of MQTT-based messaging features. Thus, the AWS IoT Core 1102 may comprise or provide an MQTT endpoint 1030 (also referred to as an MQTT message broker) configured to communicate with a cloud interface 402.

The AWS environment 1100 further includes AWS storage services that provide scalable and secure storage for data. One of the AWS storage services is Amazon Simple Storage Service (Amazon S3) 1112, which is an object storage service. When a data file is uploaded to Amazon S3 1112, the data file is stored as an S3 object in an S3 bucket 1114. An S3 bucket 1114 is a container for objects. An object consists of a file (i.e., the file data) and metadata that describes the file. A customer or producer creates an S3 bucket 1114, and specifies a bucket name and AWS region. Data is uploaded to that S3 bucket 1114 as objects, and each object has a key (or key name), which is a unique identifier for the S3 object within the S3 bucket 1114.

By default, S3 objects are private and only the object owner has permission to access the S3 objects. However, the object owner may share objects with others by creating a presigned Uniform Resource Locator (URL) 1116. A presigned URL 1116 uses security credentials to grant time-limited permission to download objects. The presigned URL 1116 may be entered in a browser or used by a program, for example, to download the object from the S3 bucket 1114. The presigned URL 1116 may also be used to upload an object to the S3 bucket 1114.

Print monitor device 310 may use MQTT protocol 1001 and/or HTTPS 1002 to upload data to technical support service 304. Print monitor device 310 may upload moderated operational data 614, status messages 616, etc., to the technical support service 304 using MQTT protocol 1001. Thus, the MQTT endpoint 1030 of print monitor device 310 may send MQTT messages 1140 to technical support service 304 containing moderated operational data 614, status messages 616, etc. Print monitor device 310 may upload moderated operational data 614, log data 630, etc., to the technical support service 304 using HTTPS 1002. Thus, the HTTPS endpoint 1032 of print monitor device 310 may send HTTP messages 1142 (e.g., HTTP POST) to technical support service 304 containing moderated operational data 614, log data 630, etc., for a printer 106. For example, the HTTPS endpoint 1032 of print monitor device 310 may upload the log data 630 to a URL (e.g., presigned URL 1116) assigned by the technical support service 304. One technical benefit is the print monitor device 310 may upload data to the technical support service 304 in a secure manner using MQTT protocol 1001 and/or HTTPS 1002.

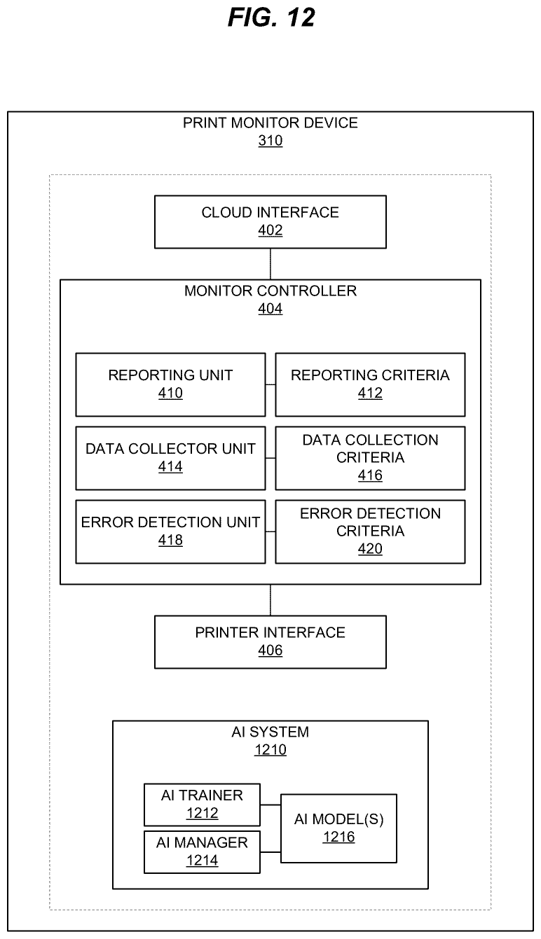

FIG. 12 is a block diagram of a print monitor device 310 in another illustrative embodiment. In an embodiment, print monitor device 310 may implement one or more Artificial Intelligence (AI) or Machine Learning (ML) systems. For example, print monitor device 310 may implement an AI system 1210 for analyzing operational and/or log data from a printer. An AI system 1210 may comprise circuitry, logic, hardware, software, means, etc., configured to perform functions described for print monitor device 310. In an embodiment, one or more AI models 1216 are trained for AI system 1210. In general, an AI model 1216 is a program or algorithm that learns from training samples to make predictions or recommendations based on a set of input data, and/or perform other functions. AI system 1210 may further include an AI trainer 1212 and an AI manager 1214. AI trainer 1212 may comprise circuitry, logic, hardware, means, etc., configured to train and/or re-train one or more AI models 1216. AI manager 1214 may comprise circuitry, logic, hardware, means, etc., configured to manage one or more AI models 1216 as trained. For example, AI manager 1214 may be configured to input data into an AI model 1216 during testing or after deployment, and receive output from the AI model 1216, along with other functions. One or more AI models 1216 may be considered generative AI models.

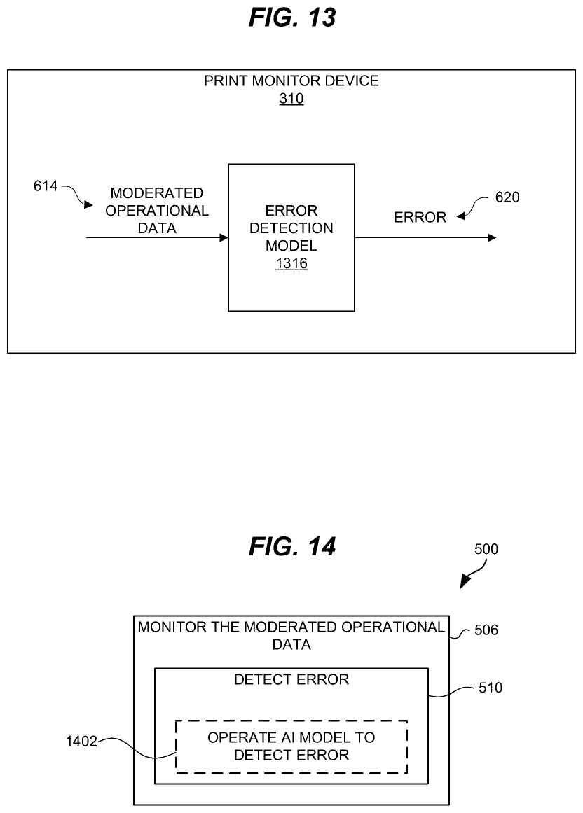

FIG. 13 is a block diagram of print monitor device 310 in an illustrative embodiment. An AI model 1216 referred to as an error detection model 1316 is trained to provide certain output based on input data. In an embodiment, the input data to the error detection model 1316 may comprise moderated operational data 614 that is streamed from a printer 106, although other input data may be used. The (trained) error detection model 1316 may generate, as output, an indication or indications of an error 620 detected at the printer 106 based on the moderated operational data 614. The output from the (trained) error detection model 1316 may comprise a classification or categorization of the error 620, such as a critical error 622, a non-critical error 624, etc. The output from the (trained) error detection model 1316 may further comprise a confidence score (e.g., a number between “0” and “1”) that represents the likelihood that the output of a model is correct. One technical benefit is the error detection model 1316 may provide improved accuracy and efficiency in detecting errors 620 at a printer 106.

FIG. 14 is a flow chart illustrating additional steps of method 500 in an illustrative embodiment. As described above in FIG. 5A, print monitor device 310 monitors the moderated operational data 614 (step 506), and detects an error 620 encountered at the printer 106 (step 510). In an embodiment, print monitor device 310 may operate error detection model 1316 to detect an error 620 at the printer 106 based on the moderated operational data 614, to classify the error 620, and/or provide other output (optional step 1402).

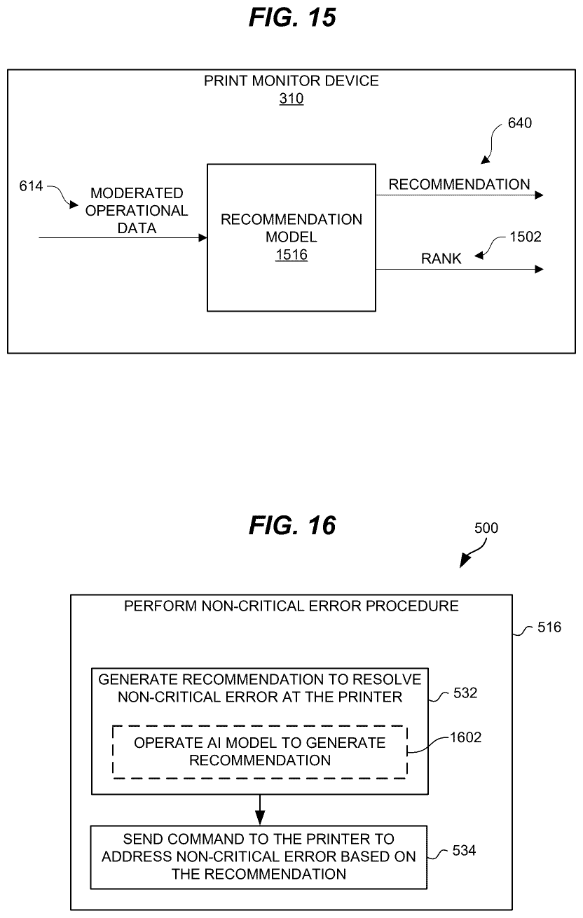

FIG. 15 is a block diagram of print monitor device 310 in an illustrative embodiment. An AI model 1216 referred to as a recommendation model 1516 is trained to provide certain output based on input data. In an embodiment, the input data to the recommendation model 1516 may comprise moderated operational data 614 that is streamed from a printer 106, although other input data may be used. The (trained) recommendation model 1516 may generate, as output, a recommendation 640 to resolve or correct an error 620 based on the moderated operational data 614. The (trained) recommendation model 1516 may generate, as output, a plurality of recommendations 640 to resolve or correct an error 620. The (trained) recommendation model 1516 may generate, as output, rankings 1502 of the recommendations 640, such as confidence scores associated with each recommendation 640. One technical benefit is the recommendation model 1516 may assist in resolving an error 620 at a printer 106 based on the outputted recommendation 640.

FIG. 16 is a flow chart illustrating additional steps of method 500 in an illustrative embodiment. As described above in FIG. 5C, when print monitor device 310 detects a non-critical error 624 at the printer 106, print monitor device 310 generates a recommendation 640 to resolve the non-critical error 624 (step 532). In an embodiment, print monitor device 310 may operate recommendation model 1516 to generate the recommendation(s) 640 (optional step 1602).

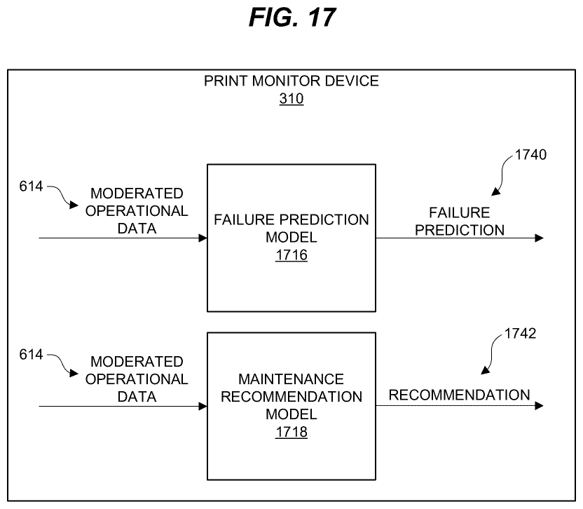

FIG. 17 is a block diagram of print monitor device 310 in an illustrative embodiment. In an embodiment, an AI model 1216 referred to as a failure prediction model 1716 may be trained to provide certain output based on input data. The input data to the failure prediction model 1716 may comprise moderated operational data 614 that is streamed from a printer 106, although other input data may be used. The (trained) failure prediction model 1716 may generate, as output, a failure prediction 1740 regarding one or more failures (e.g., in the future) at the printer 106 based on the moderated operational data 614. The output from the (trained) failure prediction model 1716 may further comprise a confidence score that represents the likelihood that the output of a model is correct. One technical benefit is the failure prediction model 1716 may forecast impending failures at a printer 106 when monitoring the moderated operational data 614.

In an embodiment, an AI model 1216 referred to as a maintenance recommendation model 1718 is trained to provide certain output based on input data. The input data to the maintenance recommendation model 1718 may comprise moderated operational data 614 that is streamed from a printer 106, although other input data may be used. The (trained) maintenance recommendation model 1718 may generate, as output, a recommendation 1742 of one or more maintenance operations at the printer 106 based on the moderated operational data 614. The output from the (trained) maintenance recommendation model 1718 may further comprise a confidence score that represents the likelihood that the output of a model is correct. One technical benefit is the maintenance recommendation model 1718 may assist a printer operator in servicing a printer 106, in preventative maintenance, etc.

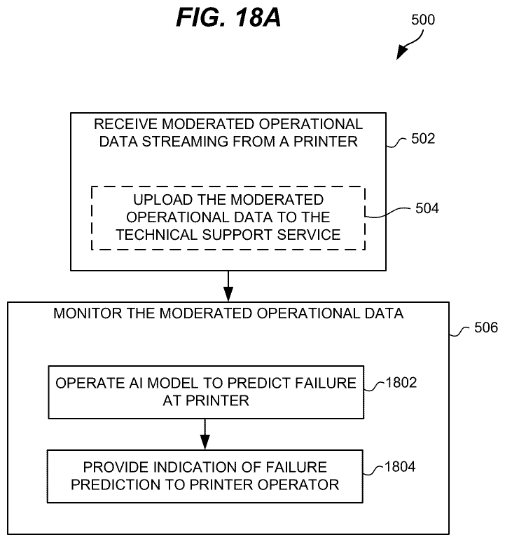

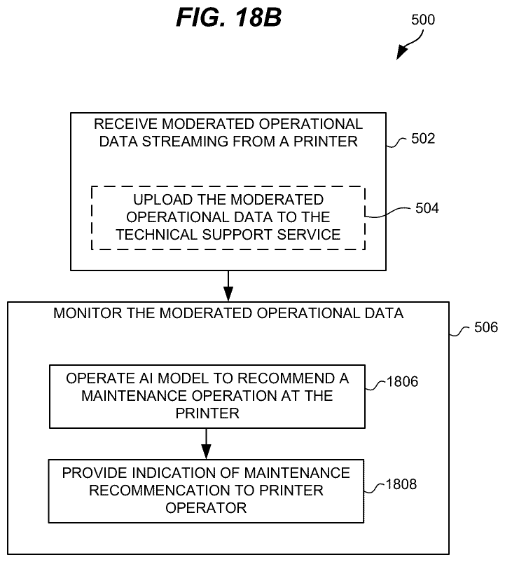

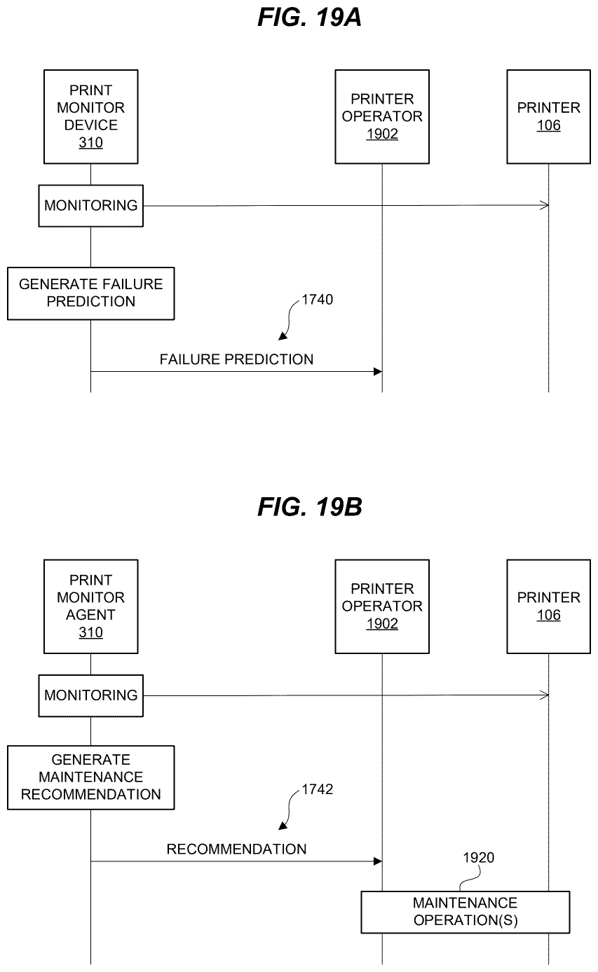

FIGS. 18A-18B are flow charts illustrating additional steps of method 500 in illustrative embodiments. In FIG. 18A, when monitoring the moderated operational data 614 (see step 506 in FIG. 5A), print monitor device 310 may operate failure prediction model 1716 to generate a failure prediction 1740 for the printer 106 (optional step 1802). The failure prediction 1740 may be for one or more components or parts of the printer 106, such as hardware components (e.g., sensors, motors, actuators, etc.), software components, etc. Print monitor device 310 may provide an indication of the failure prediction 1740 to a printer operator (optional step 1804). FIGS. 19A-19B are communication diagrams regarding communications with a printer operator in illustrative embodiments. In FIG. 19A, when generating a failure prediction 1740, print monitor device 310 provides an indication of the failure prediction 1740 to a printer operator 1902. For example, print monitor device 310 may send a text message, an email, a pop-up window to be displayed on a portal or other user interface or GUI, an instruction to display the failure prediction 1740 on an operator console on the printer 106, etc.

In FIG. 18B, when monitoring the moderated operational data 614 (see step 506 in FIG. 5A), print monitor device 310 may operate maintenance recommendation model 1718 to generate a recommendation 1742 of one or more maintenance operations at the printer 106 (optional step 1806). For example, the recommendation 1742 may comprise a cleaning operation, calibration, software/firmware updates, media handling, print engine maintenance, etc. Print monitor device 310 may provide an indication of the recommendation 1742 to a printer operator (optional step 1808). In FIG. 19B, when generating a recommendation 1742, print monitor device 310 provides the recommendation 1742 to a printer operator 1902. For example, print monitor device 310 may send a text message, an email, a pop-up window to be displayed on a portal or other user interface or GUI, an instruction to display the recommendation 1742 on an operator console on the printer 106, etc. In response to the recommendation, the printer operator 1902 may perform one or more maintenance operations 1920 on the printer 106.

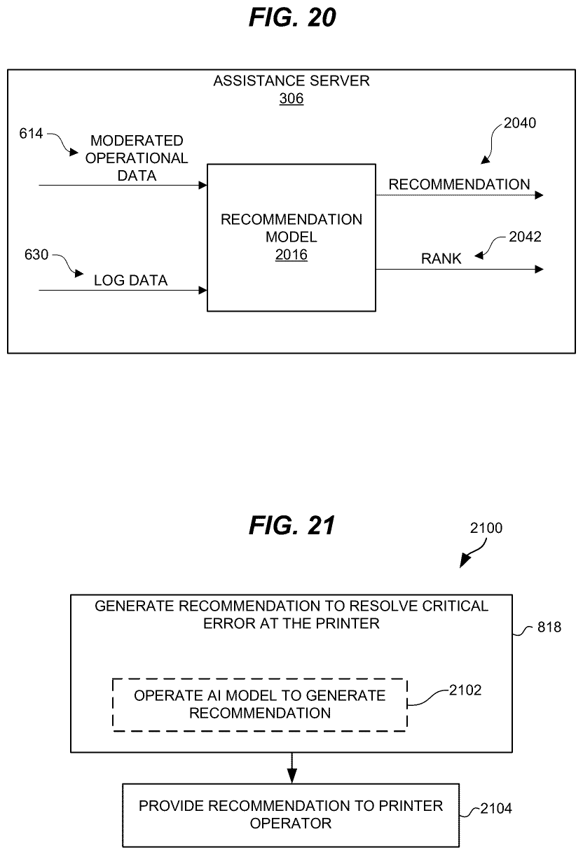

In an embodiment, an AI system 1210 as described above may be implemented in the assistance server 306 in the cloud. FIG. 20 is a block diagram of assistance server 306 in an illustrative embodiment. An AI model 1216 referred to as a recommendation model 2016 is trained to provide certain output based on input data. In an embodiment, the input data to the recommendation model 2016 may comprise moderated operational data 614 and/or log data 630 of a printer 106, although other input data may be used. The (trained) recommendation model 2016 may generate, as output, a recommendation 2040 to resolve or correct a critical error 622 based on the moderated operational data 614 and/or log data 630. The (trained) recommendation model 2016 may generate, as output, a plurality of recommendations 2040 to resolve or correct a critical error 622. The (trained) recommendation model 2016 may generate, as output, rankings 2042 of the recommendations 2040, such as confidence scores associated with each recommendation 2040. One technical benefit is the recommendation model 2016 may assist in resolving a critical error 622 at a printer 106 based on the outputted recommendation(s) 2040.

FIG. 21 is a flow chart illustrating a method 2100 of providing technical support in an illustrative embodiment. As described above in FIG. 8, when a critical error 622 is detected at the printer 106, assistance server 306 may generate a recommendation to resolve the critical error 622 (optional step 818). In an embodiment, assistance server 306 may operate recommendation model 2016 to generate the recommendation(s) 2040 (optional step 2102). Assistance server 306 may then provide the recommendation(s) 2040 to print monitor device 310, to the customer or printer operator 1902, etc. (step 2104).

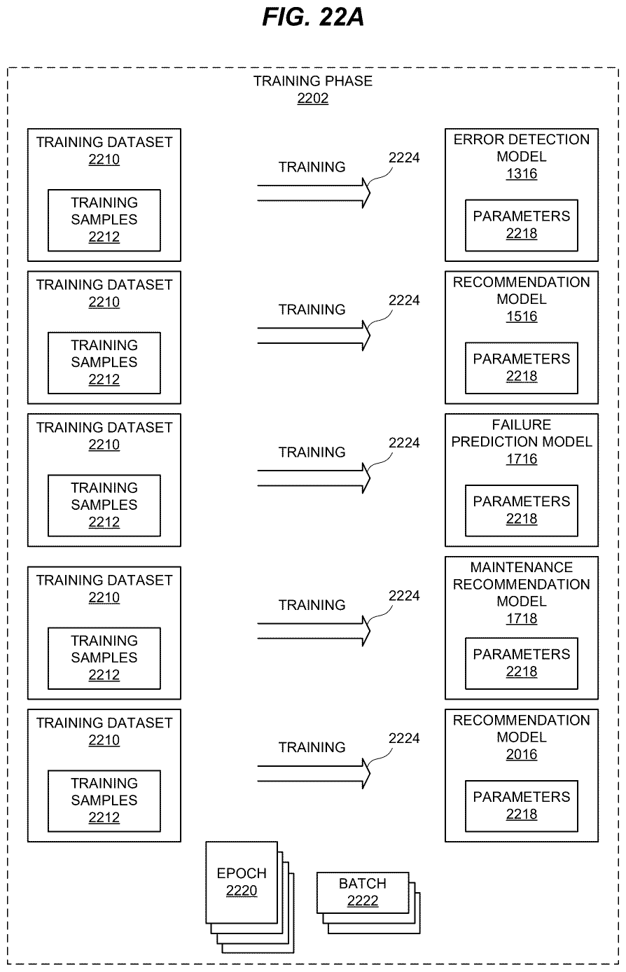

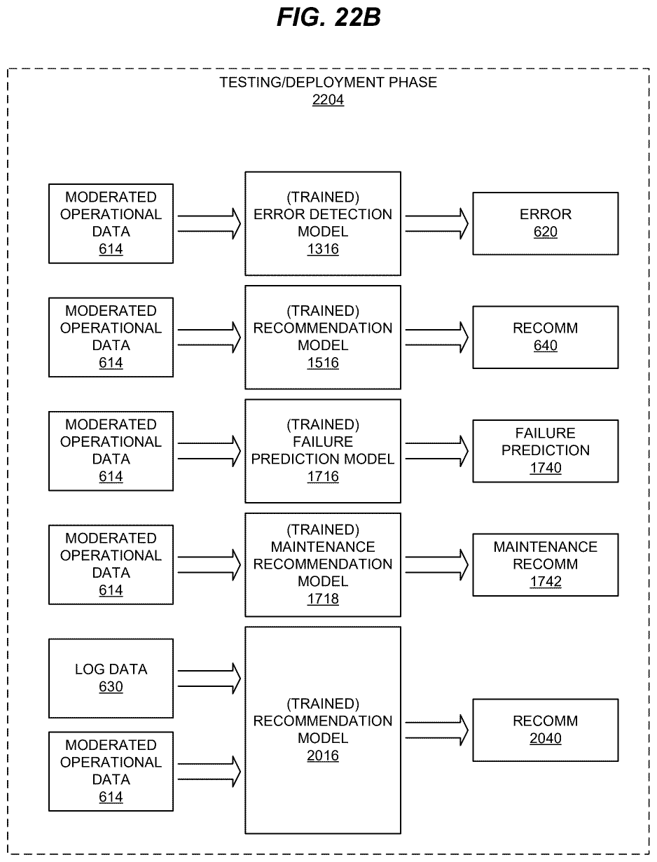

FIGS. 22A-22B are schematic diagrams illustrating training and deployment of AI models in an illustrative embodiment. An AI system 1210 of print job manager 314 or assistance server 306 may operate in a training phase 2202 (FIG. 22A), and a testing or deployment phase 2204 (FIG. 22B). In the training phase 2202 of FIG. 22A, AI trainer 1212, for example, operates to train one or more AI models. For example, AI trainer 1212 may train an error detection model 1316. AI trainer 1212 performs training 2224 of the error detection model 1316 using training samples 2212 of a training dataset 2210 to detect errors 620 in operational data 610 from a printer 106. AI trainer 1212 may train a recommendation model 1516. AI trainer 1212 performs training 2224 of the recommendation model 1516 using training samples 2212 of a training dataset 2210 to generate recommendations 640 to resolve non-critical errors 624. AI trainer 1212 may train a failure prediction model 1716. AI trainer 1212 performs training 2224 of the failure prediction model 1716 using training samples 2212 of a training dataset 2210 to generate failure predictions 1740 regarding a printer 106. AI trainer 1212 may train a maintenance recommendation model 1718. AI trainer 1212 performs training 2224 of the maintenance recommendation model 1718 using training samples 2212 of a training dataset 2210 to generate maintenance recommendations 1742 regarding a printer 106. AI trainer 1212 may train a recommendation model 2016. AI trainer 1212 performs training 2224 of the recommendation model 2016 using training samples 2212 of a training dataset 2210 to generate recommendations 2040 to resolve critical errors 622. Although like reference numbers are used to describe the training datasets 2210 and training samples 2212, it is understood that the training datasets 2210 and training samples 2212 may be different for each of the models.

During training 2204, AI trainer 1212 may train the models over a plurality of epochs 2220, which is a single iteration of training on an entire training dataset. During an epoch 2220, a model sequentially processes the training samples 2212 of the training dataset 2210, calculates loss or otherwise quantifies the predicted outputs, and updates model parameters 2218 (e.g., weights) accordingly. The number of epochs 2220 determines how many times the model iterates through the entire training dataset 2210, allowing it to learn and refine the model parameters 2218 over multiple passes. A model is trained, within an epoch 2220, in batches 2222 of training samples 2212 from the training datasets 2210. A batch 2222 is a number of training samples to work through before updating model parameters 2218.

In the testing/deployment phase 2204 of FIG. 22B, AI manager 1214, for example, may use a trained model to parse or analyze data. For example, AI manager 1214 may feed moderated operational data 614 from a printer 106 into error detection model 1316 (as trained), and error detection model 1316 outputs an indication or prediction of an error 620 at the printer 106, and may output an associated confidence score for the prediction. AI manager 1214 may feed moderated operational data 614 from a printer 106 into recommendation model 1516 (as trained), and recommendation model 1516 outputs an indication of one or more recommendations 640 to resolve or correct a non-critical error 624, and may output an associated confidence score for the recommendations. AI manager 1214 may feed moderated operational data 614 from a printer 106 into failure prediction model 1716 (as trained), and failure prediction model 1716 outputs one or more failure predictions 1740 associated with the printer 106, and may output an associated confidence score for the predictions. AI manager 1214 may feed moderated operational data 614 from a printer 106 into maintenance recommendation model 1718 (as trained), and maintenance recommendation model 1718 outputs one or more maintenance recommendations 1742 associated with the printer 106, and may output an associated confidence score for the recommendations. AI manager 1214 may feed log data 630 and/or moderated operational data 614 from a printer 106 into recommendation model 2016 (as trained), and recommendation model 2016 outputs one or more recommendations 2040 to resolve or correct a critical error 622, and may output an associated confidence score for the recommendations. It is noted that any of the models described above may be retrained on different or modified training datasets 2210 as desired.

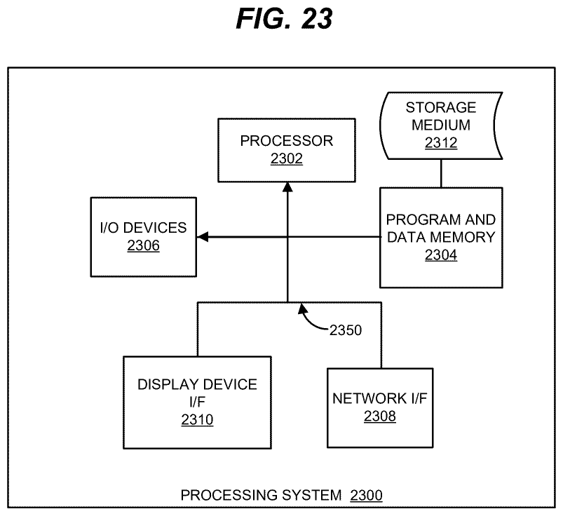

Embodiments disclosed herein can take the form of software, hardware, firmware, or various combinations thereof. FIG. 23 illustrates a processing system 2300 operable to execute a computer readable medium embodying programmed instructions to perform desired functions in an illustrative embodiment. Processing system 2300 is operable to perform the above operations by executing programmed instructions tangibly embodied on computer readable storage medium 2312. In this regard, embodiments can take the form of a computer program accessible via computer-readable medium 2312 providing program code for use by a computer or any other instruction execution system. For the purposes of this description, computer readable storage medium 2312 can be anything that can contain or store the program for use by the computer.

Computer readable storage medium 2312 can be an electronic, magnetic, optical, electromagnetic, infrared, or semiconductor device. Examples of computer readable storage medium 2312 include a solid-state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

Processing system 2300, being suitable for storing and/or executing the program code, includes at least one processor 2302 coupled to program and data memory 2304 through a system bus 2350. Program and data memory 2304 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 2306 (including but not limited to keyboards, displays, pointing devices, etc.) can be coupled either directly or through intervening I/O controllers. Network adapter interfaces 2308 may also be integrated with the system to enable processing system 2300 to become coupled to other data processing systems or storage devices through intervening private or public networks. Modems, cable modems, IBM Channel attachments, SCSI, Fibre Channel, and Ethernet cards are just a few of the currently available types of network or host interface adapters. Display device interface 2310 may be integrated with the system to interface to one or more display devices, such as printing systems and screens for presentation of data generated by processor 2302.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system according to embodiments and examples described herein.

Some embodiments pertain to Example 1 that includes an apparatus comprising a print monitor device comprising at least one processor and memory configured to cause the print monitor device at least to: receive moderated operational data streaming from a printer, monitor the moderated operational data streaming from the printer to detect an error at the printer, determine whether the error comprises a critical error based on error detection criteria, and when the error comprises a critical error based on the error detection criteria, upload a critical error indication to a cloud-based technical support service over at least one network connection, automatically collect log data from the printer, and automatically upload the log data to the cloud-based technical support service over the at least one network connection.

Example 2 includes the subject matter of Example 1, where the at least one processor and memory are further configured to cause the print monitor device at least to upload the moderated operational data to the cloud-based technical support service contemporaneously with receipt of the moderated operational data streaming from the printer.

Example 3 includes the subject matter of Examples 1 and 2, where the at least one processor and memory are further configured to cause the print monitor device at least to upload the moderated operational data to the cloud-based technical support service in one or more Message Queuing Telemetry Transport (MQTT) messages.

Example 4 includes the subject matter of Examples 1-3, where the at least one processor and memory are further configured to cause the print monitor device at least to upload at least one status message to the cloud-based technical support service indicating a status of the printer.

Example 5 includes the subject matter of Examples 1-4, where the at least one processor and memory are further configured to cause the print monitor device at least to automatically upload the log data over the at least one network connection to a Uniform Resource Locator (URL) assigned by the cloud-based technical support service.

Example 6 includes the subject matter of Examples 1-5, where the log data comprises at least one of an engine log for one or more print engines of the printer, and a print quality log for one or more color planes of the printer.

Example 7 includes the subject matter of Examples 1-6, where the at least one processor and memory are further configured to cause the print monitor device at least to operate at least one artificial intelligence model trained to detect the error in the moderated operational data.

Example 8 includes the subject matter of Examples 1-7, where the at least one processor and memory are further configured to cause the print monitor device at least to, when the error comprises a non-critical error based on the error detection criteria, generate a recommendation to resolve the non-critical error at the printer, and send a command to the printer to address the non-critical error based on the recommendation.

Example 9 includes the subject matter of Examples 1-8, where the at least one processor and memory are further configured to cause the print monitor device at least to operate at least one artificial intelligence model trained to generate the recommendation to resolve the non-critical error at the printer.

Example 10 includes the subject matter of Examples 1-9, where the at least one processor and memory are further configured to cause the print monitor device at least to perform training of the at least one artificial intelligence model based on training samples of a training dataset to generate recommendations to resolve non-critical errors.

Example 11 includes the subject matter of Examples 1-10, where the at least one processor and memory are further configured to cause the print monitor device at least to operate at least one artificial intelligence model trained to generate a failure prediction at the printer based on the moderated operational data streaming from the printer.

Example 12 includes the subject matter of Examples 1-11, where the at least one processor and memory are further configured to cause the print monitor device at least to operate at least one artificial intelligence model trained to recommend a maintenance operation at the printer based on the moderated operational data streaming from the printer.

Some embodiments pertain to Example 13 that includes a method comprising receiving moderated operational data streaming from a printer, monitoring the moderated operational data streaming from the printer to detect an error at the printer, determining whether the error comprises a critical error based on error detection criteria, and when the error comprises a critical error based on the error detection criteria, the method further comprises uploading a critical error indication to a cloud-based technical support service over at least one network connection, automatically collecting log data from the printer, and automatically uploading the log data to the cloud-based technical support service over the at least one network connection.

Example 14 includes the subject matter of Example 13, where the method further comprises uploading the moderated operational data to the cloud-based technical support service contemporaneously with receipt of the moderated operational data streaming from the printer.

Example 15 includes the subject matter of Examples 13 and 14, where the uploading of the moderated operational data comprises uploading the moderated operational data to the cloud-based technical support service in one or more Message Queuing Telemetry Transport (MQTT) messages.

Example 16 includes the subject matter of Examples 13-15, where the automatically uploading of the log data comprises automatically uploading the log data over the at least one network connection to a Uniform Resource Locator (URL) assigned by the cloud-based technical support service.

Example 17 includes the subject matter of Examples 13-16, where the method further comprises operating at least one artificial intelligence model trained to detect the error in the moderated operational data.

Example 18 includes the subject matter of Examples 13-17, wherein when the error comprises a non-critical error based on the error detection criteria, the method further comprises generating a recommendation to resolve the non-critical error at the printer, and sending a command to the printer to address the non-critical error based on the recommendation.

Example 19 includes the subject matter of Examples 13-18, where the method further comprises operating at least one artificial intelligence model trained to generate the recommendation to resolve the non-critical error at the printer.

Some embodiments pertain to Example 20 that includes a technical support system, comprising a cloud-based technical support service, and a print monitor device connected to a printer. The print monitor device is configured to receive moderated operational data streaming from the printer, monitor the moderated operational data streaming from the printer to detect an error at the printer, and determine whether the error comprises a critical error based on error detection criteria. When the error comprises a critical error based on the error detection criteria, the print monitor device is configured to upload a critical error indication to the cloud-based technical support service over at least one network connection, automatically collect log data from the printer, and automatically upload the log data to the cloud-based technical support service over the at least one network connection. The cloud-based technical support service is configured to generate a recommendation to resolve the critical error based on the log data.

Although specific embodiments were described herein, the scope of the invention is not limited to those specific embodiments. The scope of the invention is defined by the following claims and any equivalents thereof.

What is claimed is:

1. An apparatus, comprising:
a print monitor device comprising at least one processor and memory configured to cause the print monitor device at least to:
receive moderated operational data streaming from a printer;
monitor the moderated operational data streaming from the printer to detect an error at the printer;
determine whether the error comprises a critical error based on error detection criteria;
when the error comprises a critical error based on the error detection criteria:
upload a critical error indication to a cloud-based technical support service over at least one network connection;
automatically collect log data from the printer; and
automatically upload the log data to the cloud-based technical support service over the at least one network connection.

2. The apparatus of claim 1, wherein the at least one processor and memory are further configured to cause the print monitor device at least to:
upload the moderated operational data to the cloud-based technical support service contemporaneously with receipt of the moderated operational data streaming from the printer.

3. The apparatus of claim 2, wherein the at least one processor and memory are further configured to cause the print monitor device at least to:
upload the moderated operational data to the cloud-based technical support service in one or more Message Queuing Telemetry Transport (MQTT) messages.

4. The apparatus of claim 1, wherein the at least one processor and memory are further configured to cause the print monitor device at least to:
upload at least one status message to the cloud-based technical support service indicating a status of the printer.

5. The apparatus of claim 1, wherein the at least one processor and memory are further configured to cause the print monitor device at least to:
automatically upload the log data over the at least one network connection to a Uniform Resource Locator (URL) assigned by the cloud-based technical support service.

6. The apparatus of claim 1, wherein:
the log data comprises at least one of an engine log for one or more print engines of the printer, and a print quality log for one or more color planes of the printer.

7. The apparatus of claim 1, wherein the at least one processor and memory are further configured to cause the print monitor device at least to:
operate at least one artificial intelligence model trained to detect the error in the moderated operational data.

8. The apparatus of claim 1, wherein the at least one processor and memory are further configured to cause the print monitor device at least to:
when the error comprises a non-critical error based on the error detection criteria:
generate a recommendation to resolve the non-critical error at the printer; and
send a command to the printer to address the non-critical error based on the recommendation.

9. The apparatus of claim 8, wherein the at least one processor and memory are further configured to cause the print monitor device at least to:
operate at least one artificial intelligence model trained to generate the recommendation to resolve the non-critical error at the printer.

10. The apparatus of claim 9, wherein the at least one processor and memory are further configured to cause the print monitor device at least to:
perform training of the at least one artificial intelligence model based on training samples of a training dataset to generate recommendations to resolve non-critical errors.

11. The apparatus of claim 1, wherein the at least one processor and memory are further configured to cause the print monitor device at least to:
operate at least one artificial intelligence model trained to generate a failure prediction at the printer based on the moderated operational data streaming from the printer.

12. The apparatus of claim 1, wherein the at least one processor and memory are further configured to cause the print monitor device at least to:
operate at least one artificial intelligence model trained to recommend a maintenance operation at the printer based on the moderated operational data streaming from the printer.

13. A method comprising:
receiving moderated operational data streaming from a printer;
monitoring the moderated operational data streaming from the printer to detect an error at the printer;
determining whether the error comprises a critical error based on error detection criteria; and
when the error comprises a critical error based on the error detection criteria, the method further comprises:
uploading a critical error indication to a cloud-based technical support service over at least one network connection;
automatically collecting log data from the printer; and
automatically uploading the log data to the cloud-based technical support service over the at least one network connection.

14. The method of claim 13, further comprising:
uploading the moderated operational data to the cloud-based technical support service contemporaneously with receipt of the moderated operational data streaming from the printer.

15. The method of claim 14, wherein the uploading of the moderated operational data comprises:
uploading the moderated operational data to the cloud-based technical support service in one or more Message Queuing Telemetry Transport (MQTT) messages.

16. The method of claim 13, wherein the automatically uploading of the log data comprises:
automatically uploading the log data over the at least one network connection to a Uniform Resource Locator (URL) assigned by the cloud-based technical support service.

17. The method of claim 13, further comprising:
operating at least one artificial intelligence model trained to detect the error in the moderated operational data.

18. The method of claim 13, wherein:
when the error comprises a non-critical error based on the error detection criteria, the method further comprises:
generating a recommendation to resolve the non-critical error at the printer; and
sending a command to the printer to address the non-critical error based on the recommendation.

19. The method of claim 18, further comprising:
operating at least one artificial intelligence model trained to generate the recommendation to resolve the non-critical error at the printer.

20. A technical support system, comprising:
a cloud-based technical support service; and
a print monitor device connected to a printer, the print monitor device configured to receive moderated operational data streaming from the printer, monitor the moderated operational data streaming from the printer to detect an error at the printer, and determine whether the error comprises a critical error based on error detection criteria;
when the error comprises a critical error based on the error detection criteria:
the print monitor device is configured to upload a critical error indication to the cloud-based technical support service over at least one network connection, automatically collect log data from the printer, and automatically upload the log data to the cloud-based technical support service over the at least one network connection; and
the cloud-based technical support service is configured to generate a recommendation to resolve the critical error based on the log data.
